(19) United States
(12) Patent Application Publication
(10) Pub. No.: US 2018/0115552 A1
(43) Pub. Date: Apr. 26, 2018

(54) METHODS, SYSTEMS, AND APPARATUSES OF SERVICE PROVISIONING FOR RESOURCE MANAGEMENT IN A CONSTRAINED ENVIRONMENT

(71) Applicant: HUAWEI TECHNOLOGIES CO., LTD., Shenzhen (CN)

(72) Inventors: Vasu KANTUBUKTA, Bangalore (IN); Rahul Arvind JADHAV, Bangalore (IN); Neng YANG, Shenzhen (CN)

(73) Assignee: HUAWEI TECHNOLOGIES CO., LTD., Shenzhen (CN)

(21) Appl. No.: 15/838,695

(22) Filed: Dec. 12, 2017

Related U.S. Application Data
(63) Continuation of application No. PCT/CN2016/101498, filed on Oct. 8, 2016.

(30) Foreign Application Priority Data
Oct. 19, 2015 (IN) 5632/CHE/2015

(51) Int. Cl. H04L 29/06; G06F 9/50; H04L 29/08; G06F 21/62; H04L 12/24

(52) U.S. Cl. CPC H04L 63/10; G06F 9/5038; H04L 67/32; H04L 41/0893; H04L 41/5051; H04L 41/5006; G06F 21/62

(57) ABSTRACT

The disclosure provides a service provisioning method to support configurations of admission control, and resource control policies for constrained devices by using commissioning procedure. the apparatus comprises the obtaining module configured to obtain at least one service information including at least one pre-registered service along with associated device ID from said commissioning device, the creation module configured to create at least one service ID against said service information received, and create said admission control policy and/or said resource control policy for said service ID, the lookup module configured to look up service ID associated with said service in said provisioning device, on receipt of at least one request, from said client device, to access said service, and the access module configured to grant/deny access for said service, based on said policies decided, to said client device.

### CROSS-REFERENCE TO RELATED APPLICATIONS

This application is a continuation of International Application No. PCT/CN2016/101498, filed on Oct. 8, 2016, which claims priority to India Application No. IN5632/CHE/2015, filed on Oct. 19, 2015. The disclosures of the aforementioned applications are hereby incorporated by reference in their entireties.

### TECHNICAL FIELD

The present disclosure described herein, in general, relates to communication networks, and more particularly, to systems, methods, and apparatuses of service provisioning for resource management in constrained environment based on resource directory.

### BACKGROUND

The research on Constrained Restful Environment (CoRE/CORE) is aimed to realize the restful architecture for constrained devices (as clearly discussed in the RFC7228) in constrained networks (discussed in RFC4944). The CORE work group has recently standardized constrained application protocol (CoAP) (discussed in RFC7252) for interacting with constrained resources where general HTTP is not memory/energy efficient as shown in FIG. 1. The use of web linking for resources description and discovery hosted by constrained web servers is specified by CORE (discussed in RFC6690). Even though, CoAP allows the direct resource access for constrained devices, it is not advisable for direct access of resources in the networks where multicast procedures are infeasible due to heavy network load, and the networks where sleepy nodes exist. So, the CoRE working group comes up with a solution called resource directory (RD) to host the devices service information, and allow other devices to perform lookup procedures through well-known/core path to resources as shown in FIG. 2.

The services advertised by these constrained devices needs to be commissioned and provisioned properly to allow other devices to access it. CoRE RD solution is a directory based solution that depends on CoAP protocol. CORE RD solution uses registration/update/delete/lookup procedures for service registration, service update, deleting service, lookup of services respectively. Service commissioning is a method which verifies a pre-registered services with special commissioning tools/agents. These tools can be tablets or special embedded devices which initially stores the devices identifications in secure manner. Once the services are advertised by any device, those services need to be verified using commissioner. CORE RD provides a standard procedure to interact with commissioner, where commissioner acts like a client device to look up and verify the advertised services. Once the commissioner verifies the pre-registered services, commissioner can put some policy rules on services hosted by devices for resource control. These rules defined on (1) how to access the services either with other constrained devices or client devices, and (2) on operational instructions.

Architecture is defined to authenticate and authorize client requests for a resource on a server using logical entities such as client (C), client authorization manager (CAM), server (S), and server authorization manager (SAM) [draft-gerdes-ace-actors] as shown in FIG. 3. FIG. 4 illustrates an IETF solutions/architecture to authenticate and authorize client requests for a resource on a server using logical entities. The main goal of delegated CoAP authentication and authorization framework (DCAF) is the setup of a datagram transport layer security channel between two nodes to securely transmit authorization tickets. The CAM sends an access request message on behalf of client by embedding requested permissions in client authorization information (CAI) field of access request message to SAM. A ticket grant message is sent from SAM by embedding the permissions given from the server on a specific resource in server authorization information (SAI) field of ticket grant message to the client. These SAI, CAI use authorization information format (AIF) that describes the permissions requested from access request in a ticket request, where the underlying access control model will be that of an access matrix, which gives a set of permissions for each possible combination of a subject and an object. This simple information model also doesn't allow conditional access (e.g., “resource/s/tempC is accessible only if client belongs to group 1 and does not belong to group2”). Finally, the model does not provide any dynamic functions such as enabling special access for a set of resources that are specific to a subject. But, the services provided by resources in constrained environment, need to be authorized and controlled conditionally based on some service level agreements or preconfigured policies on resource control.

In spite of having different technical solutions in the prior-art (including the above mentioned), in case of resource constrained environment, the resource management is critical along with authorization, where the service provisioning based on some service level negotiations between the clients and resources plays vital role. Moreover, it is required to provision the resource access threshold for clients before admitting at a particular time, otherwise it causes the network bandwidth to loose. Further, the resource management where the conditional access service provisioning based on some service level negotiations between the clients and resources within the constrained environment of a particular registered user is necessary.

In view of the above issues, the person skilled in that art is provided with a technical solution of using access control lists for resource control. Access controls are usually implemented in two main methods: access control list (ACL) and capabilities, which generally have four basic operations such as allowing access, denying access, limiting access, and revoking access. ACLs are usually used to control access in the file systems on which our operating systems run. There are two types of ACLs: File System ACLs, and Network ACLs.

File System ACL: ACLs in most file systems commonly use three permissions in use: read, write, and execute, respectively allowing us to access the file or directory, write to file or directory, and execute the contents of file. For example in UNIX like operating systems, separate access control list for a given file in the form of user, group is seen. Various permissions to different users or groups can be given. By using such sets of file permissions, one can control the operating system and its applications that utilize the file system. Microsoft and UNIX-like operating systems use this kind of access control lists. These kinds of ACLs follow simple access permissions (i.e. read, write, and execute) for various files or directories such as Linux or Windows OSs; however, these are not applicable in scenarios where it needs a dynamic way of ACL because in networks one needs to control the flow of traffic.

However, the above type of methods (ACL's) are not applicable to constrained network environment, because the constrained environments are limited in terms of memory, power consumption of devices, and reliability. So, it always needs a conditional approaches for access control which protects resource from hazardous conditions, robust in operations, and improves the device lifetime. This kind of conditional access control always checks for certain conditions or criteria to be met for service access before granting the service access. Even though similar approaches are being used for content broadcasting for TV systems and for telecommunications systems, the conditional access control systems are much different in the constrained environments because the constrained devices are less in capability in terms nodes, scalability, networks, and message sizes, it altogether needs a different architecture for machine to machine communication.

In view of the above, there exists a need to provide a new and efficient technique that solves the problem of supporting dynamic way of conditional access and resource control policies on different clients based on network conditions and device capabilities in resource constrained environment.

### SUMMARY

This summary is provided to introduce concepts related to methods, systems, and apparatuses of service provisioning for resource management in a constrained environment, and are further described below in the detailed description. This summary is not intended to identify essential features of the claimed subject matter nor is it intended for use in determining or limiting the scope of the claimed subject matter.

In order to provide a technical solution to support dynamic way of conditional access and resource control policies on different clients based on network conditions and device capabilities in resource constrained environment, one aspect of the present disclosure is to provide a system, method and apparatus for configuring the policies for dynamic admission and resource control of constrained devices by allowing conditional access for various clients by using commissioning procedure that brings many advantages such as, security, maximizing device lifetime, QoS improvement, improvement on network throughput, and easy maintenance.

Another aspect of the present disclosure is to provide a system, method and apparatus for service provisioning method for accessing devices service in two different use cases:
a. Firstly, provision the service when non-constrained device accessing service provided by constrained device.
b. Secondly, provision the service when one constrained device accessing service provided by other constrained device.

Another aspect of the present disclosure is to provide a system, method and apparatus for provisioning server that play a key role for authorizing, and efficiently managing the resources by providing conditional admission and resource control policies on each resource based on clients service level agreements.

Yet another aspect of the present disclosure is to provide a system, method and apparatus that enables to access the provisioning technique from outside the constrained environment.

Still another aspect of the present disclosure is to a system, method and apparatus that enables to provide conditional access service provisioning, and dynamic resource control of constrained devices.

Accordingly, in one implementation, the present disclosure provides a system for provisioning at least one admission control policy and/or at least one resource control policy to at least one service in a network, said network having at least one constrained device providing said service registered with at least one resource discovery device, and at least one client device accessing said service. The system comprises at least one commissioning device and at least one provisioning device. The commissioning device is configured to perform a domain lookup in said resource discovery device, obtain a specific domain and a specific group of services to which said service is categorized, and verify at least one service pre-registered with said resource discovery device to obtain at least one service information including at least one pre-registered service along with associated device identification (ID). The provisioning device configured to receive said service information from said commissioning device, create at least one service identification (ID) against said service information received, and transmit said service identification (ID) to said commissioning device. The commissioning device, on receipt of said service ID is configured to create said admission control policy and/or said resource control policy for said service ID; and on receipt of at least one request, from said client device to access said service, look up service ID associated with said service in said provisioning device. The client device is granted/denied access for said service, based on said admission control policy and/or said resource control policy.

In one implementation, the present disclosure provides a system for provisioning at least one admission control policy and/or at least one resource control policy to at least one service in a network, said network having at least one constrained device providing said service registered with at least one resource discovery device, at least one client device accessing said service registered on said resource discovery device, and at least one commissioning device configured to verify said constrained device providing said service. The system comprises at least one provisioning device configured to obtain at least one service information including at least one pre-registered service along with associated device identification (ID) from said commissioning device, create at least one service identification (ID) against said service information received, create said admission control policy and/or said resource control policy for said service ID. On receipt of at least one request, from said client device, to access said service, the client device looks up service ID associated with said service in said provisioning device; and thereby grants or denies access for said service, based on said admission control policy and/or said resource control policy, to said client device.

In one implementation, the present disclosure provides an apparatus for provisioning at least one admission control policy and/or at least one resource control policy to at least one service in a network, said network having at least one constrained device providing said service registered with at least one resource discovery device, at least one client device accessing said service registered on said resource discovery device, and at least one commissioning device configured to verify said constrained device providing said service. The apparatus comprises an obtaining module, a creation module, a lookup module, and an access module.

The obtaining module is configured to obtain at least one service information including at least one pre-registered service along with associated device identification (ID) from said commissioning device. The creation module is configured to create at least one service identification (ID) against said service information received, and create said admission control policy and/or said resource control policy for said service ID. The lookup module is configured to look up service ID associated with said service in said provisioning device, on receipt of at least one request, from said client device, to access said service. The an access module is configured to grant/deny access for said service, based on said admission control policy and/or said resource control policy, to said client device.

In one implementation, the present disclosure provides a method for provisioning at least one admission control policy and/or at least one resource control policy to at least one service in a network, said network having at least one constrained device providing said service registered with at least one resource discovery device, and at least one client device accessing said service, said method comprising:
performing, by at least one commissioning device in said network, a domain lookup in said resource discovery device;
obtaining, by said commissioning device, a specific domain and a specific group of services to which said service is categorized;
verifying, by said commissioning device, at least one service pre-registered with said resource discovery device to obtain at least one service information including at least one pre-registered service along with associated device identification (ID);
receiving, by at least one provisioning device in said network, said service information from said commissioning device;
creating, by said provisioning device, at least one service identification (ID) against said service information received;
creating, by said commissioning device on receipt of said service ID, said admission control policy and/or said resource control policy for said service ID; and
on receipt of at least one request, from said client device, to access said service, looking up service ID associated with said service in said provisioning device, thereby granting/denying access for said service, based on said admission control policy and/or said resource control policy, to said client device.

In one implementation, the present disclosure provides a method for provisioning at least one admission control policy and/or at least one resource control policy to at least one service in a network, said network having at least one constrained device providing said service registered with at least one resource discovery device, at least one client device accessing said service registered on said resource discovery device, and at least one commissioning device configured to verify said constrained device providing said service. The method comprising:
obtaining, by at least one provisioning device in said network, at least one service information including at least one pre-registered service along with associated device identification (ID) from said commissioning device;
creating, by said provisioning device, at least one service identification (ID) against said service information received;
creating, by said provisioning device, said admission control policy and/or said resource control policy for said service ID;
on receipt of at least one request, from said client device, to access said service, looking up, by said provisioning device, service ID associated with said service in said provisioning device; and thereby granting/denying, by said provisioning device, access for said service, based on said admission control policy and/or said resource control policy, to said client device.

In one implementation, the present disclosure provides a method for provisioning at least one admission control policy and/or at least one resource control policy to at least one service in a network, said network having at least one constrained device providing said service registered with at least one resource discovery device, at least one client device accessing said service registered on said resource discovery device, and at least one commissioning device configured to verify said constrained device providing said service, said method comprising:
obtaining, by at least one apparatus in said network, at least one service information including at least one pre-registered service along with associated device identification (ID) from said commissioning device;
creating, by said provisioning device, at least one service identification (ID) against said service information received;
creating, by said apparatus, said admission control policy and/or said resource control policy for said service ID;
on receipt of at least one request, from said client device, to access said service, looking up, by said apparatus, service ID associated with said service in said apparatus; and thereby granting/denying, by said apparatus, access for said service, based on said admission control policy and/or said resource control policy, to said client device.

In one implementation, an apparatus is disclosed. The apparatus comprises a processor, and a memory coupled to the processor for executing a plurality of modules present in the memory. The plurality of modules comprises an obtaining module configured to obtain at least one verified service information associated with at least pre-registered service provided by at least one resource; a creation module configured to create at least one service registry holding the verified service information obtained, create at least one service identification (ID) against the service registry created, and create at least an admission control policy and/or at least a resource control policy for the service ID created; a lookup module, on receipt of at least one request from at least one client device to access the services, configured to look up services provided by the resources; and an access module, based on availability of the service requested by the client device, configured to grant admission to access the service provided by the resource, based on the admission control policy and/or the resource control policy.

As compared to the prior-art techniques, the present disclosure enables to achieve supporting dynamic way of conditional access and resource control policies on different clients based on network conditions and device capabilities using commissioning procedure.

### BRIEF DESCRIPTION OF THE ACCOMPANYING DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates CoAP Application Protocol as available in the prior-art.

FIG. 2 illustrates an example of resource directory (RD) storing paths of various resources available in the network, as available in the prior-art.

FIG. 3 illustrates an architecture is defined to authenticate and authorize client requests for a resource on a server using logical entities, as available and known in the prior-art.

FIG. 4 illustrates an IETF solutions/architecture to authenticate and authorize client requests for a resource on a server using logical entities, as per the prior-art technique.

FIG. 5 illustrates constrained device accessing service from constrained device (system), in accordance with an aspect of the present disclosure.

FIG. 6 illustrates a client device accessing service from constrained device (system), in accordance with an aspect of the present disclosure.

FIG. 7 illustrates a network topology, in accordance with an aspect of the present disclosure.

FIG. 8 illustrates an apparatus for provisioning at least one admission control policy and/or at least one resource control policy to at least one service in a network, in accordance with an aspect of the present disclosure.

FIG. 9 illustrates a process of authorization, admission, and resource control of device services, in accordance with an aspect of the present disclosure.

FIG. 10 illustrates a method for provisioning at least one admission control policy and/or at least one resource control policy to at least one service in a network, in accordance with an aspect of the present disclosure.

FIG. 11 illustrates a process of registering a service, in accordance with an aspect of the present disclosure.

FIG. 12 illustrates a process of verifying a pre-registered service, in accordance with an aspect of the present disclosure.

FIG. 13 illustrates a process of defining policies on resource control, in accordance with an aspect of the present disclosure.

FIG. 14 illustrates an exemplary permissions on methods/devices, in accordance with an aspect of the present disclosure.

FIG. 15 illustrates a process of group and QoS classification for clients, in accordance with an aspect of the present disclosure.

FIG. 16 illustrates a process of searching for services by device, in accordance with an aspect of the present disclosure.

FIG. 17 illustrates a process of request/response within constrained environment, in accordance with an aspect of the present disclosure.

FIG. 18 illustrates a process of request/response from outside constrained environment, in accordance with an aspect of the present disclosure.

FIG. 19 illustrates a constrained device accessing service from constrained device while requesting device verifying the authority from provisioning server in accordance with an aspect of the present disclosure.

FIG. 20 illustrates a process of request/response in scenario 3 as provide in FIG. 19, in accordance with an aspect of the present disclosure.

FIG. 21 illustrates constrained device accessing service from constrained device via. Provisioning server, in accordance with an aspect of the present disclosure.

FIG. 22 illustrates a process of Request/Response in scenario 4 as provide in FIG. 21, in accordance with an aspect of the present disclosure.

FIG. 23 illustrates Scenario 1: constrained device accessing service from client device, Scenario 2: constrained device accessing service from constrained device, in accordance with an aspect of the present disclosure.

FIG. 24 illustrates Scenario 3: constrained device accessing service from constrained device with pre verification by provisioning server. Scenario 4: Constrained device accessing service from constrained device via provisioning server, in accordance with an aspect of the present disclosure.

FIG. 25 illustrates a method for authorizing at least one client device to access at least one service provided by at least one resource, and managing access of the resource by providing conditional admission and/or resource control on the service provided by the resource based on service level agreement, in accordance with an aspect of the present disclosure.

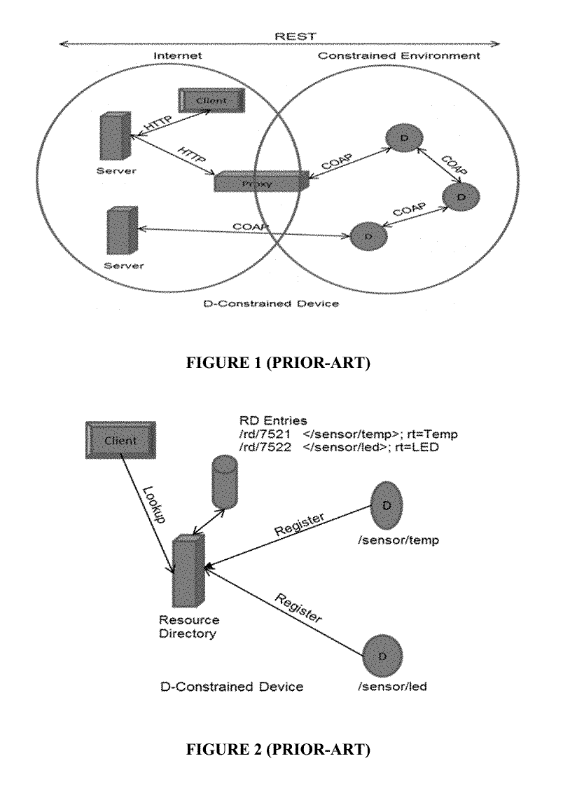

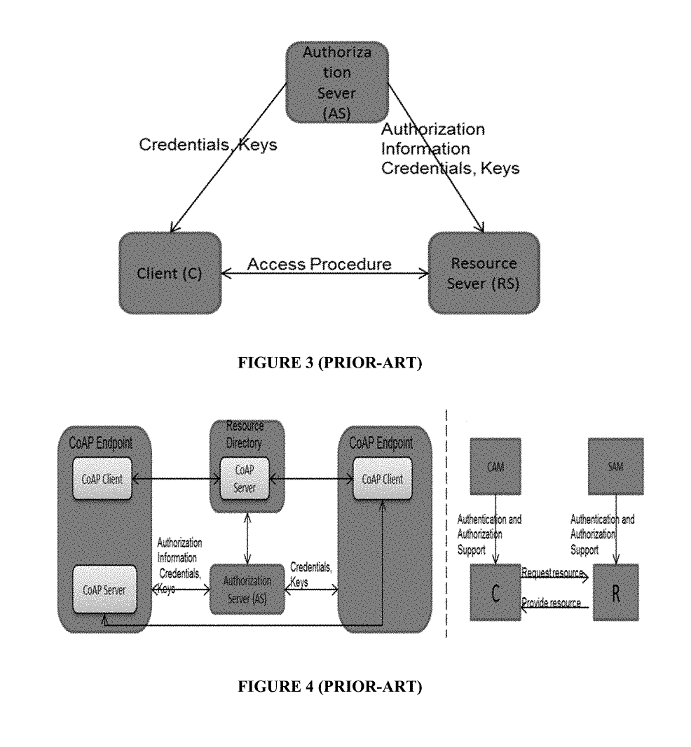

It is to be understood that the attached drawings are for purposes of illustrating the concepts of the disclosure and may not be to scale.

### DETAILED DESCRIPTION OF THE PRESENT DISCLOSURE

The following clearly describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

The disclosure can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the disclosure may take, may be referred to as techniques. In general, the order of the steps of disclosed processes may be altered within the scope of the disclosure.

A detailed description of one or more embodiments of the disclosure is provided below along with accompanying figures that illustrate the principles of the disclosure. The disclosure is described in connection with such embodiments, but the disclosure is not limited to any embodiment. The scope of the disclosure is limited only by the claims and the disclosure encompasses numerous alternatives, modifications and equivalents. Numerous specific details are set forth in the following description in order to provide a thorough understanding of the disclosure. These details are provided for the purpose of example and the disclosure may be practiced according to the claims without some or all of these specific details. For the purpose of clarity, technical material that is known in the technical fields related to the disclosure has not been described in detail so that the disclosure is not unnecessarily obscured.

Service provisioning systems, methods and apparatuses to support configurations of admission control, and resource control policies for constrained devices by using commissioning procedure are disclosed.

While aspects are described for providing service provisioning systems, methods and apparatuses to support configurations of admission control, and resource control policies for constrained devices by using commissioning procedure, the present disclosure may be implemented in any number of different computing systems, environments, and/or configurations, the embodiments are described in the context of the following exemplary systems, apparatus, and methods.

In one implementation, the present disclosure enables to provision the service when non-constrained device accessing service provided by constrained device.

In one implementation, the present disclosure enables to provision the service when one constrained device accessing service provided by other constrained device.

The service provisioning method enables the conditional access of resources for different clients based on service level agreements.

In one implementation, a centralized provisioning server provides dynamic functions such as enabling a special access for a set of resources by keeping admission and resource control policies.

In one implementation, the resource control policies are expressed in terms of conditional expressions (also known as statements (ST)).

In one implementation, the Service provisioning method enables the conditional access of resources for different clients based on service level agreements. This centralized provisioning server provides dynamic functions such as enabling a special access for a set of resources by keeping admission and resource control policies. (Note: R-Read, W-Write, D-Delete, C-Client, g-group, P-Priority, Q-QoS level, O-Operation (ex. pause, play, rewind, restart etc. for IP camera)).

| | |
|---|---|
| AC { | RC { |

| | |
|---|---|
| Service ID: 12345 | If C is from g1 allow {R,W} with P1, Q1, O1 |
| Auth: Basic Auth Support | If C is from g2 & !g3 {R} with P2, O2 |
| Count: 10 | If C is from d1 & g1 allow {R, W, D}, P1, O3 |
| Admission Control: R, W,R/W, D | : |
| : | : |
| : | : |

| | |
|---|---|
| } | } |

| | |
|---|---|
| Example Admission Control (AC) Policies | Example Resource Control (RC) Policies |

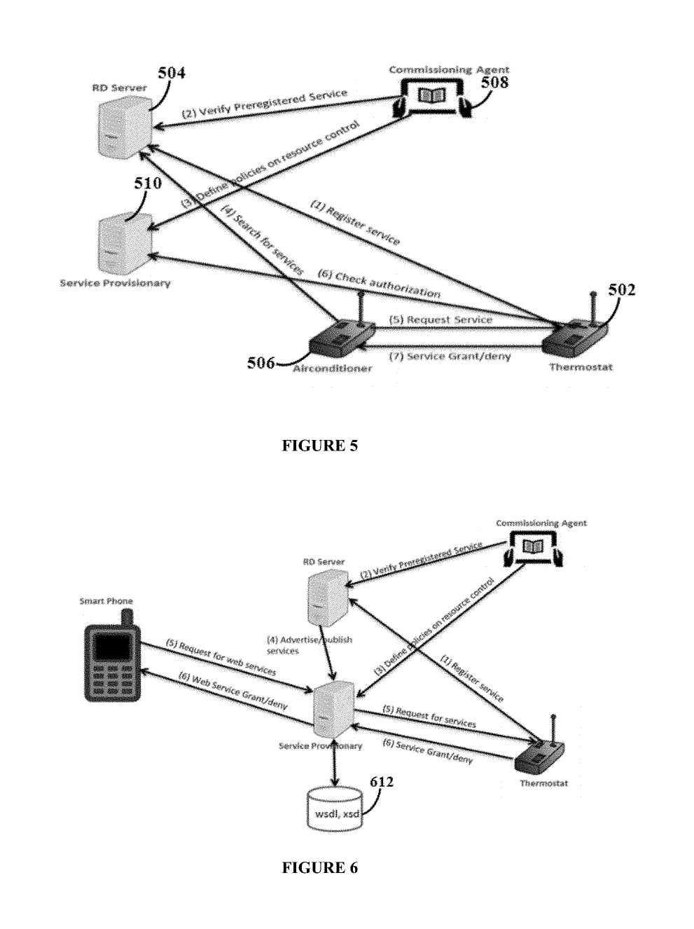

In one implementation, a system architecture when constrained device access the service advertised by other constrained device is as shown in FIG. 5. Here, one constrained device (502) such as air-conditioner can access the service such as current room temperature advertised by other constrained device (ex. thermostat). This advertised service is to be commissioned by commissioner (508), and then it should be set with some admission and resource control policies by provisioning server (510). And, finally the service is allowed to advertise its service access from other constrained devices (506). Any device (506) that is interested in that advertised service, need to do service lookup from RD Server (504). Once obtaining the path to the advertised service, the constrained client device (506) can request a service to the device (502) which hosts the service. Once the incoming request comes from the constrained client device (506), the device (502) which hosts the service must authorize and provision for conditional access of its service from the provisioning server (510). The notification regarding the registered services to the commissioning agent can be sent from the RD server (504).

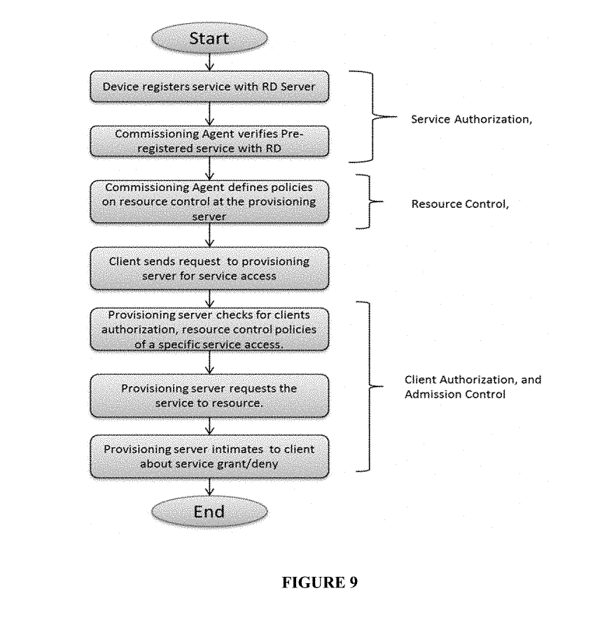

In one implementation, a system architecture when client device access the service advertised by constrained device is as shown in FIG. 6, and FIG. 9 provides the details of the provisions method in accordance with the present disclosure. For example, the client device (506) such as smart phone may access the service (ex. room temperature) advertised by other constrained device (ex. thermostat) (502). The client (506) can access the service within a home environment or outside the home environment. So, in this scenario, the provisioning server (510) maintains the service as a web service. This advertised service is to be commissioned by commissioner (508), then to be set with some admission and resource control policies by provisioning server (510). And, finally the service is allowed to advertise its access from the client devices (506). Any client (506) that wishes to access this web service looks for corresponding operations provided from the provisioning server (510).

However, the implementation depends on how WSDL files are provided for the corresponding web service. WSDL is an XML-based service description for endpoints in constrained environment. These files for each device that hosts a specific web service must be deployed before publishing the service at the provisioning server. Any client that implements to access this web service must look for those files of device at the URL of provisioning server, and then need to implement the web service with the provided methods of hosted service. Once the incoming request comes from the client device, the provisioning server must authorize and provision for conditional access of resource. Then, the provisioning server should get the service from the hosted device and relay the response back to client based on service access level.

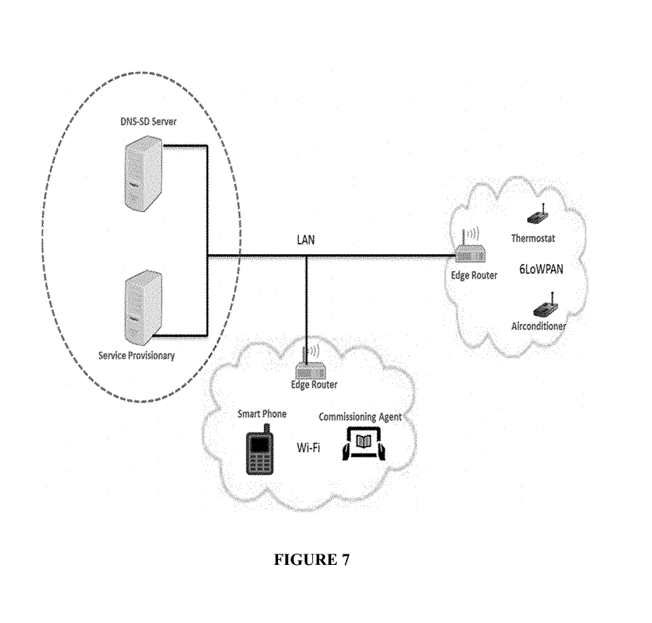

In one implementation, a network topology of the constrained device intercommunicating within the constrained network is as shown in FIG. 7. The constrained devices such as but not limited to thermostat, Air-conditioner may use small memory constrained sensors/actuators for simple services such as cooling/heating the room or just to measure the current room temperature. These memory constrained embedded devices may implement the 6LoWPAN stack such as uIP (provided by Contiki), and provide access for communication to other external queries from client devices such as smart phone which typically implements rich stack TCP/IP. Even though the RD server (504) or Provisioning server (510) are shown as separate servers in the LAN as given in FIG. 7, these can be hosted on a single server running two different processes. On the other hand, these specific operations can be implemented separately as a third party and to be used at the commissioning agent. The lower level communication technology can be implemented either through Bluetooth (BT) or near field communication (NFC) to verify the devices unique ID (for ex. using MAC). Even though the present document discusses about 6LoWPAN based sensor network, it can be easily moved to any other technology such as Zigbee/BLE/Wireless HART without any changes in the architecture or design, because the present document abstracted the communication networks with their edge routers.

Accordingly, in one implementation, the present disclosure provides a system for provisioning at least one admission control policy and/or at least one resource control policy to at least one service in a network, said network having at least one constrained device (502) providing said service registered with at least one resource discovery device (504), and at least one client device (506) accessing said service. The system comprises at least one commissioning device (508) and at least one provisioning device (510). The commissioning device (508) is configured to perform a domain lookup in said resource discovery device, obtain a specific domain and a specific group of services to which said service is categorized, and verify at least one service pre-registered with said resource discovery device to obtain at least one service information including at least one pre-registered service along with associated device identification (ID). The provisioning device (510) is configured to receive said service information from said commissioning device, create at least one service identification (ID) against said service information received, and transmit said service identification (ID) to said commissioning device. The commissioning device (508), on receipt of said service ID is configured to create said admission control policy and/or said resource control policy for said service ID; and on receipt of at least one request, from said client device to access said service, look up service ID associated with said service in said provisioning device. The client device (506) is granted/denied access for said service, based on said admission control policy and/or said resource control policy.

In one implementation, the present disclosure provides a system for provisioning at least one admission control policy and/or at least one resource control policy to at least one service in a network, said network having at least one constrained device (502) providing said service registered with at least one resource discovery device (504), at least one client device (506) accessing said service registered on said resource discovery device (504), and at least one commissioning device (508) configured to verify said constrained device (502) providing said service. The system comprises at least one provisioning device (510) configured to obtain at least one service information including at least one pre-registered service along with associated device identification (ID) from said commissioning device (508), create at least one service identification (ID) against said service information received, create said admission control policy and/or said resource control policy for said service ID. On receipt of at least one request, from said client device (506), to access said service, the client device looks up service ID associated with said service in said provisioning device; and thereby grant/deny access for said service, based on said admission control policy and/or said resource control policy, to said client device.

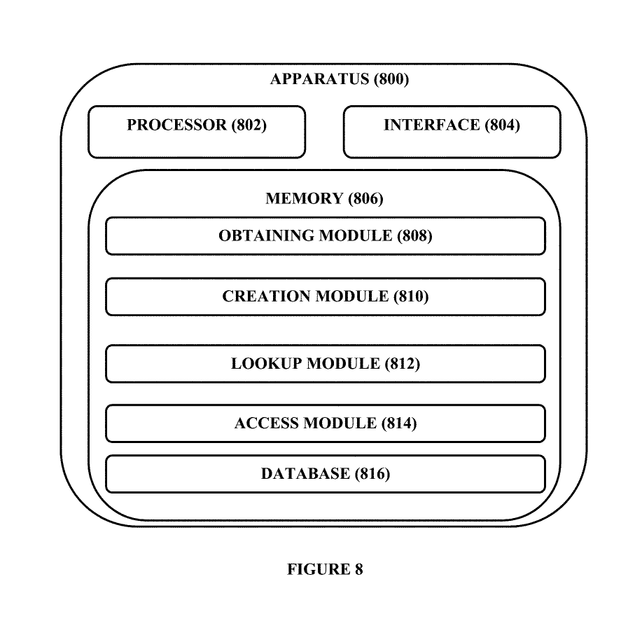

FIG. 8 illustrates an apparatus 800 for provisioning at least one admission control policy and/or at least one resource control policy to at least one service in a network. In one implementation, the present disclosure provides an apparatus (800) for provisioning at least one admission control policy and/or at least one resource control policy to at least one service in a network, said network having at least one constrained device (502) providing said service registered with at least one resource discovery device (504), at least one client device (506) accessing said service registered on said resource discovery device (504), and at least one commissioning device (508) configured to verify said constrained device (502) providing said service.

Although the present disclosure is explained considering that the apparatus (800) for provisioning at least one admission control policy and/or at least one resource control policy to at least one service in a network, it may be understood that the apparatus (800) may also be implemented in a variety of computing systems, such as a laptop computer, a desktop computer, a notebook, a workstation, a mainframe computer, a server, a network server, and the like. It will be understood that the apparatus (800) may be accessed by multiple users through one or more user devices (not shown) or applications residing on the user devices. Examples of apparatus (800) may include, but are not limited to, a portable computer, a personal digital assistant, a handheld device, and a workstation, routers, servers. The apparatus (800) are communicatively coupled to the other devices (502, 506, and 508) through a network (not shown).

In one implementation, the network may be a wireless network, a wired network or a combination thereof. The network can be implemented as one of the different types of networks, such as intranet, local area network (LAN), wide area network (WAN), the internet, and the like. The network may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network may include a variety of network devices, including routers, bridges, servers, computing devices, storage devices, and the like.

In one implementation, the apparatus (800) may include at least one processor (802), an input/output (I/O) interface (804), and a memory (806). The at least one processor (802) may be implemented as one or more microprocessors, microcomputers, microcontrollers, digital signal processors, central processing units, state machines, logic circuitries, and/or any devices that manipulate signals based on operational instructions. Among other capabilities, the at least one processor (802) is configured to fetch and execute computer-readable instructions stored in the memory (806).

The I/O interface (804) may include a variety of software and hardware interfaces, for example, a web interface, a graphical user interface, and the like. The I/O interface (804) may allow the apparatus (800) to interact with a user directly or through the client devices (not shown). Further, the I/O interface (804) may enable the apparatus (800) to communicate with other computing devices, such as web servers and external data servers (not shown). The I/O interface (804) can facilitate multiple communications within a wide variety of networks and protocol types, including wired networks, for example, LAN, cable, etc., and wireless networks, such as WLAN, cellular, or satellite. The I/O interface (804) may include one or more ports for connecting a number of devices to one another or to another server.

The memory (806) may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory (804) may include modules and database (816).

The modules include routines, programs, objects, components, data structures, etc., which perform particular tasks or implement particular abstract data types.

In one implementation, the modules may an obtaining module (808), a creation module (810), a lookup module (812), and an access module (814). The obtaining module is configured to obtain at least one service information including at least one pre-registered service along with associated device identification (ID) from said commissioning device. The creation module is configured to create at least one service identification (ID) against said service information received, and create said admission control policy and/or said resource control policy for said service ID. The lookup module is configured to look up service ID associated with said service in said provisioning device, on receipt of at least one request, from said client device, to access said service. The access module is configured to grant/deny access for said service, based on said admission control policy and/or said resource control policy, to said client device.

In one implementation, the modules may an obtaining module (808), a creation module (810), a lookup module (812), and an access module (814). The obtaining module may be configured to obtain at least one verified service information associated with at least pre-registered service provided by at least one resource. The creation module may be configured to create at least one service registry holding the verified service information obtained; create at least one service identification (ID) against the service registry created; and create at least an admission control policy and/or at least a resource control policy for the service ID created. The lookup module, on receipt of at least one request from at least one client device to access the services, may be configured to look up services provided by the resources. The access module, based on availability of the service requested by the client device, may be configured to grant admission to access the service provided by the resource, based on the admission control policy and/or the resource control policy.

In one implementation, said admission control policy is at least one of read (R), write (W), read/write (R/W), delete (D), number of simultaneous connection on a resource, or any combination thereof.

In one implementation, said resource control policy is a conditional access of a service, and/or quality of service agreements/parameters based on priority levels set for said client device and depending on at least one application used by said client device.

In one implementation, said quality of service agreements/parameters is at least one of availability, reliability, serviceability, data accuracy, aggregation delay, coverage, fault tolerance, network lifetime or any combination thereof, associated with said network.

In one implementation, said quality of service (QoS) agreements/parameters are categorized in at least one group, at least one priority, at least one class, and at least one permission.

In one implementation, said conditional access is at least one conditional statement defining said resource control policy, selected from: if a client belongs to a G1 then it is allowed with permissions {R, R/W, U}, priority {P1}, QoS {Q1}, and operations {turn it up, read}; else if the client belongs to a G2 then it is allowed with permissions {R, W, R/W}, priority {P3}, QoS {Q2}, and operations {turn it up, read}; else if the client belongs to a G3 then it is allowed with permissions {D}, priority {P2}, QoS {Q3}, and operations {turn it down}; or the client with priority {P1}, QoS {Q1}, operations {turn it up, turn it down, read}, and allow only with permissions {R} in a G1; permissions {R, R/W, D} in a G2; and permissions {D} in a G3; or the client with priority {P1}, QoS {Q1}, and allow with permissions {R}, operations {read} in G1; allow with permissions {R, R/W, D}, operations {turn it up, turn it down, read} in G2; and allow with permissions {D}, operations {turn it down} in G3; or any combination thereof; Where, the priorities for different groups are as {group 1 (G1), group 2 (G2), group 3 (G3)}=>{priority 1 (P1), priority 3 (P3), priority 2 (P2)}.

In one implementation, said service information comprises at least one of device identification, a group in which said device categorized, a domain detail, a type of device, a device IP, or any combination thereof.

In one implementation, on receipt of said request, from said client device, to access said service, said client device is configured to: look up all the service information hosted by all constrained devices in said network; search for domain for specific service, service information associated said specific services and path associated with said specific services.

In one implementation, said apparatus is configured to store said service information in the form of a web service in at least one database (816).

In one implementation, said apparatus is configured to store said service information in the form of a web service in a Web Services Description Language (WSDL) format in at least one database (816).

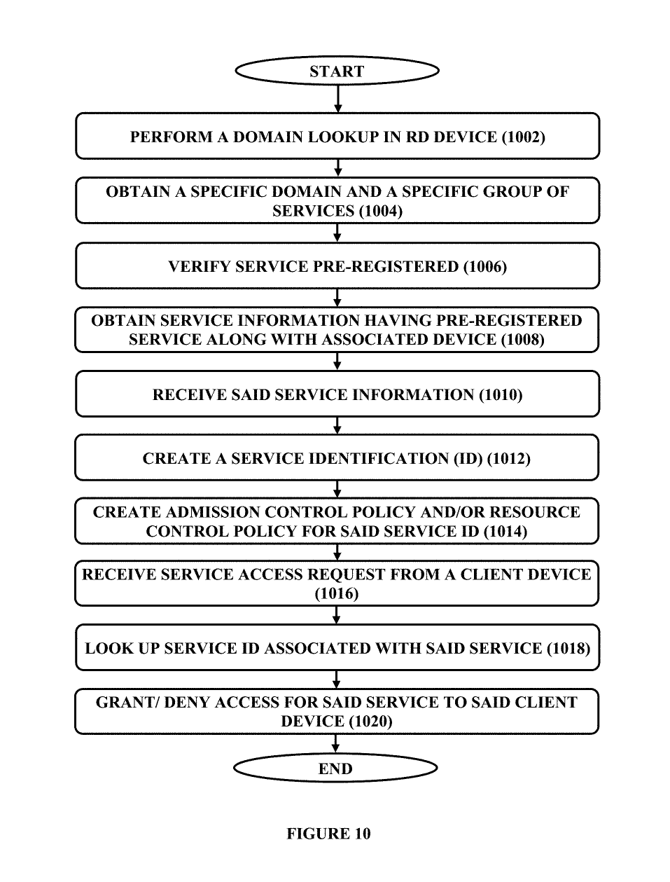

FIG. 10 illustrates a method for provisioning at least one admission control policy and/or at least one resource control policy to at least one service in a network, in accordance with an aspect of the present disclosure. The method may be described in the general context of computer executable instructions. Generally, computer executable instructions can include routines, programs, objects, components, data structures, procedures, modules, functions, etc., that perform particular functions or implement particular abstract data types. The method may also be practiced in a distributed computing environment where functions are performed by remote processing devices that are linked through a communications network. In a distributed computing environment, computer executable instructions may be located in both local and remote computer storage media, including memory storage devices.

The order in which the method is described is not intended to be construed as a limitation, and any number of the described method blocks can be combined in any order to implement the method or alternate methods. Additionally, individual blocks may be deleted from the method without departing from the protection scope of the subject matter described herein. Furthermore, the method can be implemented in any suitable hardware, software, firmware, or combination thereof. However, for ease of explanation, in the embodiments described below, the method may be considered to be implemented in the above described systems and apparatuses.

In one implementation, the major steps involved in the present disclosure are as given below:

1. Register Services

2. Verify pre-registered services

3. Define policies on resource controls

4. Search for services by devices

5. Services request and response

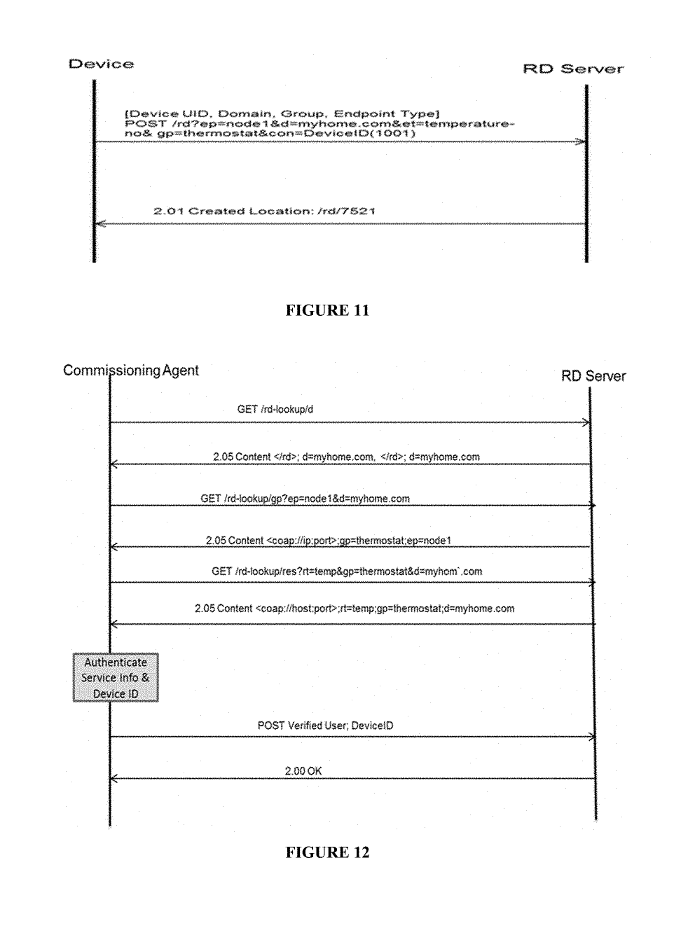

Register Service: The constrained device which hosts the service must register its service with the RD server using its unique identifier (for ex. MAC id, UDDI registry etc.) and IP address as shown in FIG. 11. The device must send a POST request for registering its service. Once the service has been registered with the RD server, the RD server may notify the registered information of a device (for ex., the unique identifier and device name) to a commissioning agent.

Verify pre-registered service: The commissioning agent must verify any pre-registered service with the RD server as shown in FIG. 12. The commissioning agent sends a GET request for domain lookup. Once obtaining the specific domain, it must look for the group to which the service belongs. Once obtaining the specific domain and group, it must send a service look up with the RD server for the registered service. Once obtaining the service information about a specific device, the commissioning agent must verify the registered service. This service information is later used to create service registry in the provisioning server as explained in the following section. The example service information (denoted as SRV) looks like as shown below:

SRV {

Name: Node1
Group: Thermostat
Domain: myhome.com
Type: Temperature node
Device ID: 1001
Device IP: <host:port>

}

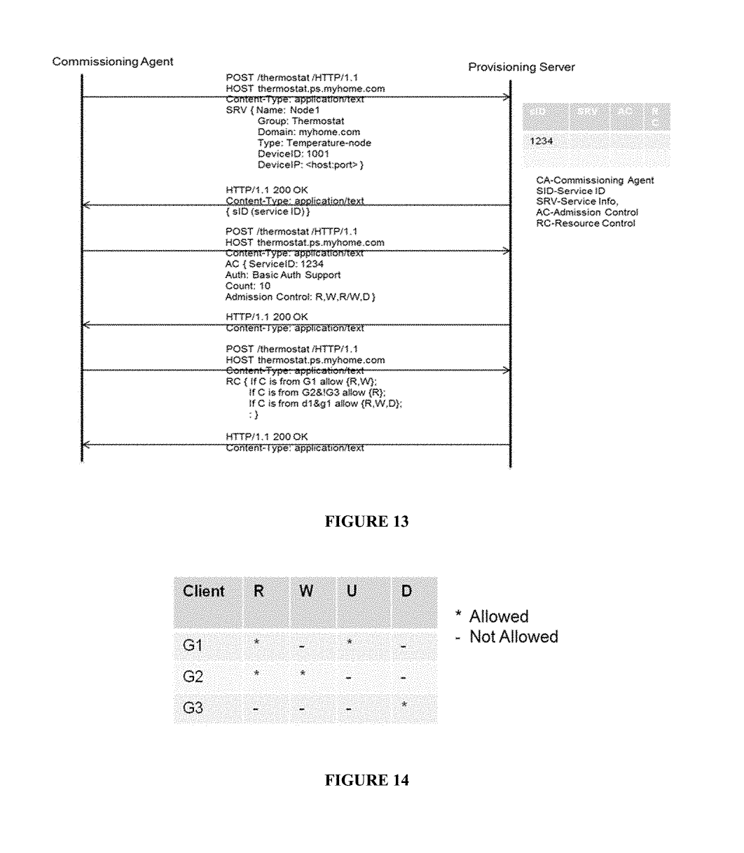

Define policies on resource control: Once the hosted service has been verified by commissioning agent (CA), the CA must create a service registry with the provisioning server as explained in FIG. 13. The provisioning server should send a service ID as a response back to the commissioning agent after creating the service entry. This service ID can be later used by the commissioning agent to permanently DELETE the service entry (if required). The commissioning agent must create some admission control policies such as read (R), write (W), read/write (R/W), delete (D), number of simultaneous connection on resource etc. on the registered service. Once the admission control policies has been set on a specific device, the resource control policies such as conditional access of a service, quality of service agreements (based on the priority levels set for clients) can be set on that registered service. These conditional access on service can be implemented with simple conditional statements as explained in subsection resource control (for ex. “client (c) can access service with only read (R), write (W) permissions if it only belongs to group (g)”). The example admission control and resource control policies are as shown below:

AC {

Service ID: 12345
Auth: Basic Auth Support
Count: 10
Admission Control: R, W, R/W, D
:
:

```
  }
  RC {
```

If C is from g1 allow {R,W}
If C is from g2 & !g3 {R}
If C is from d1 & g1 allow {R, W,

D}

:
:

:

}

Resource Control: Resource control policies for constrained devices are expressed in terms of conditional expressions as explained in the example above. Consider a scenario where we define the client (who accesses the resource) in terms of groups/levels. For example in a typical home building, we assign each floor as a group. Suppose for a three floor building, the clients such as mobile phone/air conditioner can belong to any of the floor within a building. And we allow various permissions for the clients according to the group it belongs to, as specified in FIG. 14.

In one implementation, suppose, the priorities for different groups as C={G1, G2, G3}=>{P1, P3, P2} are assigned. Moreover, if different QoS classes for clients are assigned, depending on the applications they use, it is required to control QoS policies in resource control. QoS may be defined in terms of various parameters such as {availability, reliability, serviceability, data accuracy, aggregation delay, coverage, fault tolerance, network lifetime} in wireless sensor networks. It is assumed that based on these parameters, QoS is defined in terms of various classes such as {Q1, Q2, Q3}, then it is required that some of the clients can make some pre-level agreements on QoS requirement for their applications either based on the groups it belongs to or based on the priority of the clients request (Suppose, C={Q1, Q2, Q3}). Once defining the groups, its priorities, QoS classes, and permissions, then the conditional statements which define the resource control policies can be defined as follows:

ST1: If the client belongs to G1 then it is allowed with permissions {R, R/W, U}, priority {P1}, QoS {Q1}, and operations {turn it up, read}; else if the client belongs to G2 then it is allowed with permissions {R, W, R/W}, priority {P3}, QoS {Q2}, and operations {turn it up, read}; else if the client belongs to G3 then it is allowed with permissions {D}, priority {P2}, QoS {Q3}, and operations {turn it down}.

ST2: Allow the client with priority {P1}, QoS {Q1}, operations {turn it up, turn it down, read}, and allow only with permissions {R} in G1; permissions {R, R/W, D} in G2; and permissions {D} in G3.

ST3: Allow the client with priority {P1}, QoS {Q1}, and allow with permissions {R}, operations {read} in G1; allow with permissions {R, R/W, D}, operations {turn it up, turn it down, read} in G2; and allow with permissions {D}, operations {turn it down} in G3.

It may be understood by the person skilled in that art that, the above conditional statements are few examples on how to define the conditional statements, the statements can be defined on any manner based on the resource control policies we would like to achieve.

In order to understand the above statements in better way, the above statements may be better explained in plain semantic notation (a) as below, and the corresponding JSON representations (b) for message exchange in explained below:

C
{

G1
{

| Allow {R, U} | |
|---|---|
| Priority {P1} | ″[ |
| QoS {Q1} | ″C″:{″G1″:{″Allow″:″R,U″,″Priority″: |
| Operations {turn it up, | ″P1″,″QoS″:″Q1″,″Operations″:″turn |

| read} | | it up,read″}, |
|---|---|---|
| | } | ″G2″:{″Allow″:″R,W″,″Priority″:″P3″, |
| | G2 | ″QoS″:″Q2″,″Operations″:″turn it up, |
| | { | read″}, |

| | |
|---|---|
| Allow {R,W} | ″G3″:{″Allow″:″D″,″Priority″:″P2″, |
| Priority {P3} | ″QoS″:″Q3″,″Operations″:″turn it |
| QoS {Q2} | down″}} |
| Operations {turn it up, | ]″ |

| | |
|---|---|
| read} | (b) |

```
  }
  G3
  {
```

Allow {D}
Priority {P2}
QoS {Q2}
Operations {turn it

down}

}

}

(a)

C
{

| Priority {P1} | |
|---|---|
| QoS {Q1} | ″[ |
| Operations {turn it up, read} | ″Priority″:″P1″,″QoS″:″Q1″, |
| G1 | ″Operations″:″turn it up, |
| { | turn it |

| | |
|---|---|
| Allow {R} | down, read″, |

| | |
|---|---|
| } | ″C″:{″G1″:{″Allow″:″R″}, |
| G2 | ″G2″:{″Allow″:″R,W,D″}, |
| { | ″G3″:{″Allow″:″D″}} |

| | |
|---|---|
| Allow {R,W,D} | ]″ |

}
G3
{

Allow {D}

}

}

| | |
|---|---|
| (a) | (b) |

C
{

| | |
|---|---|
| Priority {P1} | ″[ |
| QoS {Q1} | ″Priority″:″P1″,″QoS″:″Q1″, |
| G1 | ″C″:{″G1″:{″Allow″:″R″, |
| { | ″Operations″:″read″}, |

| | |
|---|---|
| Allow {R} | ″G2″:{″Allow″:″R,W,D″,″Op |
| Operations {read} | erations“ |

| | |
|---|---|
| } | :″turn it up, turn it down, |
| G2 | read“ |
| { | }, |

| | |
|---|---|
| Allow {R,W,D} | ″G3″:{″Allow″:″D″,″Operati |
| Operations {turn it up, | ons″: |

| turn it down, read} | | ″turn it down″}} |
|---|---|---|
| | } | ]″ |

G3
{

Allow {D}
Operations {turn it down}

}

}

| | |
|---|---|
| (a) | (b) |

In one implementation, it may be understood that the QoS parameters in wireless sensor networks may vary depending on the application domain. So, it may be to the service provider to decide what kind of QoS parameters to consider, and derive the QoS classes and Groups who utilizes the provisioning server. A simple method for deriving QoS classes for sample QoS parameters such as {Availability (A), Reliability (R), Serviceability (S), Data Accuracy (DA), Delay (D), Coverage (C), Lifetime (L)}, is defined as:

Qn=aA+rR+sS+pDA+dD+cC+lL

Where {a,r,s,p,d,c,l} are weights between {0-1} which vary depending upon QoS classes to be defined. Suppose service provider defines weights as {Low (0), Medium (0.5), High (1)}, and QoS class Q1 as more delay tolerant but needs more reliability, then Q1 is defined as:

Q1=0.5*A+1*R+0.5*S+0.5*DA+0*D+0.5*C+0.5*L

Similarly, QoS class Q2 is defined as more delay sensitive, then Q2 is defined as:

Q2=0.5*A+0.5*R+0.5*S+0.5*DA+1*D+0.5*C+0.5*L

The above QoS parameter can be estimated using standard well-known procedures for example,

Availability=Mean_Time_Between_Failure/(Mean_Time_Between_Failure+Mean_Time_To_Repair); and

Reliability=1−(t/Mean_Time_Between_Failure), t-time period.

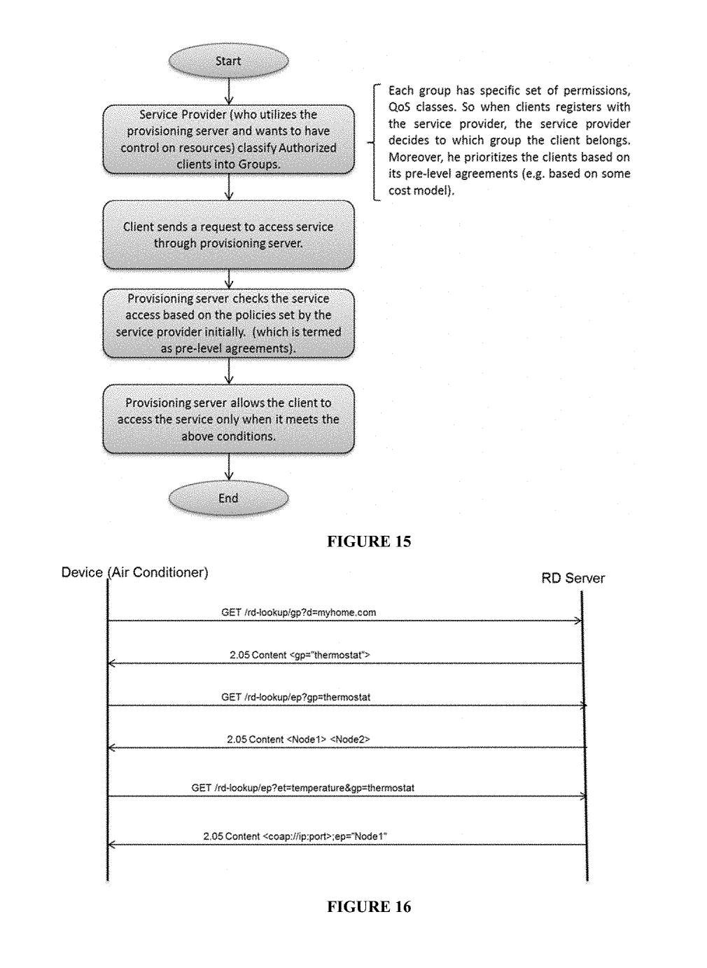

In one implementation, once the service provider classifies the QoS classes, then he can use different mappings among groups with QoS Classes. Suppose, group G1 only provides Q1, group G2 provides {Q1, Q2}. And the client which uses a specific service is defined as Group G1, and then the client can be provided only with assurance of QoS Q1 to access that particular service. Moreover, before accessing the service, the client is checked with its authorization permissions which were set specific to a group (already mentioned in the IDF). A step wise explanation for Group and QoS classification for clients is as shown in FIG. 15.

In one implementation, the conditional statements can be used to set resource control policies. For example, if nth client belongs to mth group then the conditional expression is expressed as follows:

Cn
{

Gm
{
Allow {x1,...xk}€{R,W,R/W,U,D}; k is number of

permissions allowed for client

Priority {p1,p2,....pr}; r is total priority classes of client
QoS {Q1,Q2,.....Qs}; s is total QoS classes allowed for client
Operations {O1,O2,.......On};n is total possible operations for

client

}

}

Search for services by device: Any client device (as explained for scenario 2 explained in FIG. 6) may interact with the provisioning server and looks for deployed services by devices. Moreover, the provisioning server may verify the complete authorization, admission, and resource control of any device's services. Whereas, if any other constrained devices (ex. air conditioner) searches for services hosted by other constrained device (as explained for scenario 1) must interact with the RD server as shown in FIG. 16. Here, initially the device queries for all services that are hosted by other devices, then it searches within the domain for specific service, its SRV info, and path to the hosted service.

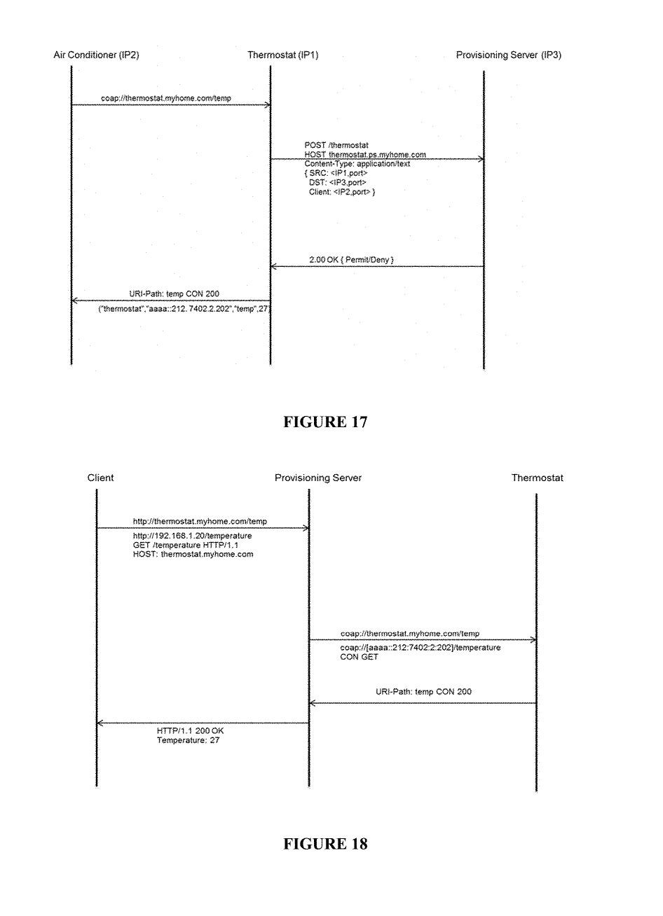

Service request and response: In scenario 1 (as shown in FIG. 5), service request and response must use CoAP based communication to access the service as shown in FIG. 17. Suppose, the constrained client device (for ex. air-conditioner) want to access the service hosted by another constrained device (for ex. thermostat), then the client device must send a coap based GET request to thermostat. Then, this device (thermostat) should send a POST request to provision this service request with the provisioning server by sending clients <IP:port>. Based on the clients <IP:port>, the provisioning server must find the client (ex. air-conditioner) details such as service information, group, domain, and type details. Once the client is identified, the provisioning server must check for authorization, admission and resource control policies of hosted service (ex. thermostat). Once the service request is authorized to access then the URI-Path for hosted service along with the value is sent as a coap response to client device (air conditioner). Here, the request is conditional i.e. based on the resource control policies of a resource (such as thermostat) for a client (air-conditioner), the permissions are given to access the resource.

Service request and response in scenario 2 (as shown in FIG. 6), uses simple http based communication to access the service from the PS is shown in FIG. 18. Provisioning Server then sends a coap based GET request to the ultimate device that hosts service. Before sending this request to the actual device for service, PS authorizes the service request. Once, the service request is authorized to access, and then the URI-path for hosted service along with the value is sent as HTTP response to client device.

Sometimes it is required to provide the sensor services over the Internet when the client is outside the home environment (for ex. from office using mobile Internet or using cloud). So to provide the sensor services in the web world, it is essential to represent to the sensor services in a web service model. WSDL is a XML based communication standard to represent the services over Internet by making the client independent of their platforms and implementation technologies, which is widely used due to its great tool support. A client connecting to a web service can read the WSDL to determine what functions is available regarding the sensor service over Internet. Any special data types are embedded in the WSDL file in the form of XSD. The client can use SOAP to actually call one of these functions provided by the sensor device which are listed in WSDL file.

So in scenario 2, the request/response to sensor services follows the web service model. This web service model can implement RESTful or SOAP based frameworks for accessing/publishing the web service. Web linking within constrained environments is expressed in a restful way; where as a general way to represent a resource outside the constrained environments is based on SOAP. The sample request and response code for these frameworks are given below. WSDL is an XML-based service description for endpoints in constrained environment and is being used by SOAP protocol outside the constrained environment, where this WSDL representation allows an abstract way of representing the endpoint services regardless of what message formats or network protocols are used to communicate.

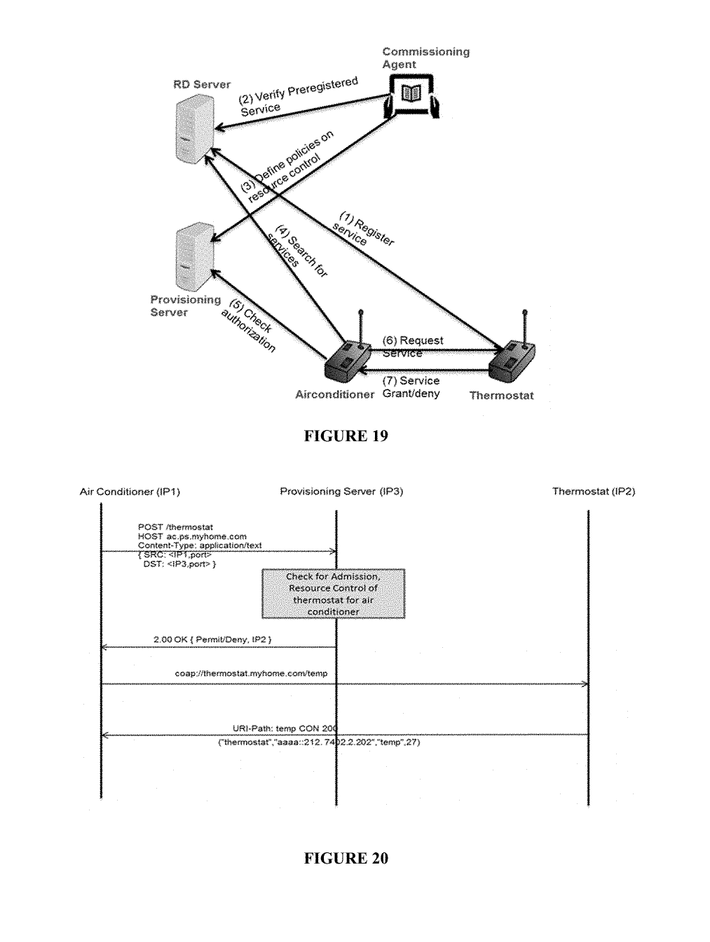

In one scenario 3, any device that wishes to access service from other constrained device must verify its accessibility from the provisioning server before sending request to the constrained device is shown in FIG. 19, and the call flow for the same is as shown in FIG. 20. Because, for example in the scenario 1 (FIG. 5), where multiple requests sent to thermostat from various other devices then it becomes more overloaded in terms of processing power. Moreover, for each request the thermostat must verify client's accessibility with the provisioning service which may increase the delay in sending response to the clients. So, by using this scenario 3 (FIG. 19), the constrained devices can operate efficiently in terms of processing power, faster response time, and network efficiency. The constrained device accessing the service from other constrained device while requesting device verifying the admission and resource policies for service accessibility from the PS is as shown in FIG. 19.

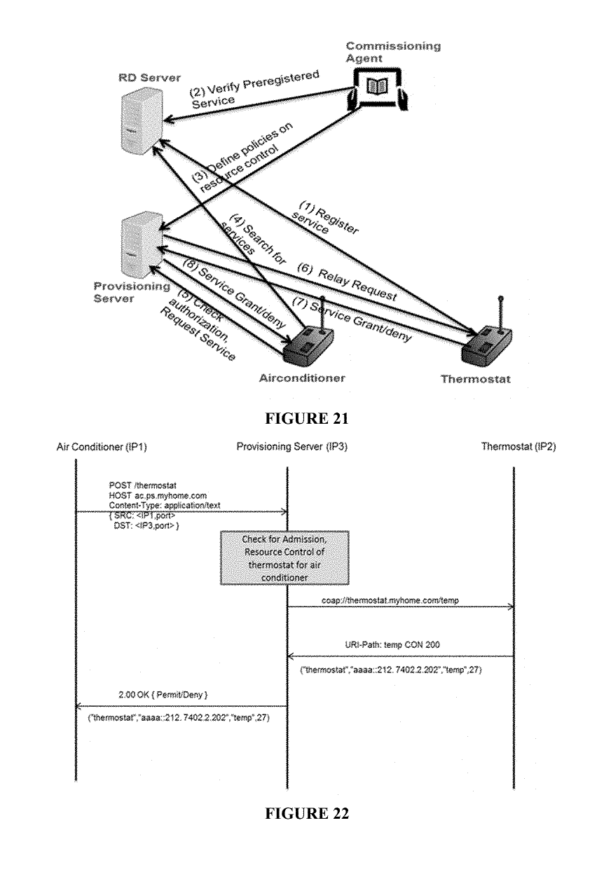

In scenario 4, any device that wishes to access service from other constrained device must verify its accessibility from the provisioning server before sending request to the constrained device is shown in FIG. 21, and the call flow for the same is as shown in FIG. 22. Moreover, in contrast to scenario 3, the provision server itself relay the request on behalf of any constrained device to other constrained device that hosts the service and sends the response back to the requested device. This protects the constrained devices from hazardous conditions, and improves the security of devices along with the advantages points mentioned in the scenario 3. The constrained device accessing the service from other constrained device via PS is as shown in FIG. 21, while FIG. 22 shows the call flow.

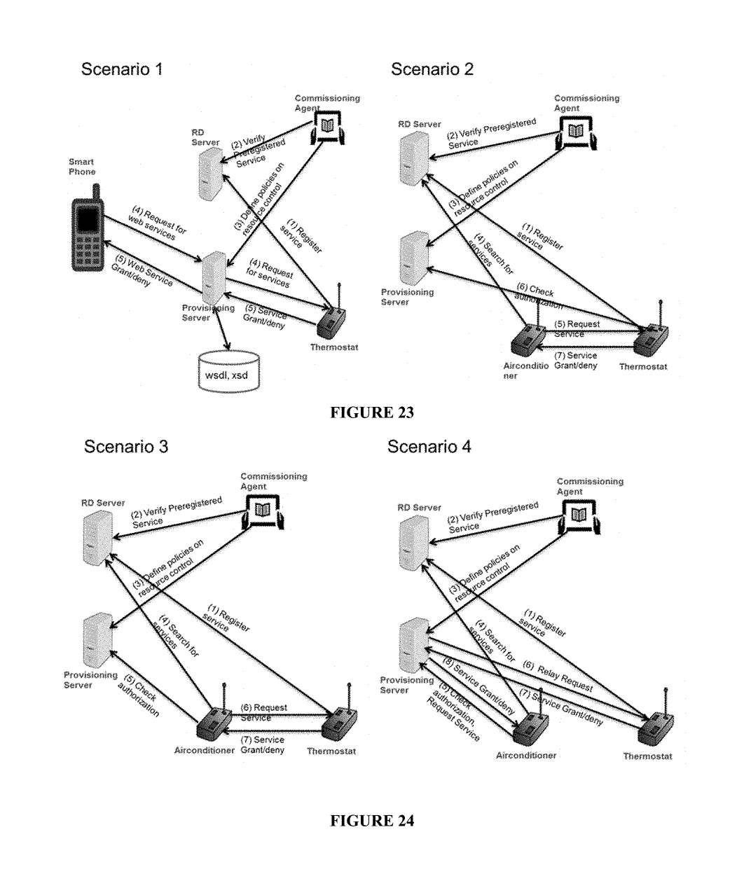

In one implementation FIG. 23 and FIG. 24 shows all the four scenarios as explained in the present disclosure as an exemplary embodiment.

In one implementation, as shown in FIG. 10, a method for provisioning at least one admission control policy and/or at least one resource control policy to at least one service in a network, said network having at least one constrained device providing said service registered with at least one resource discovery device, at least one client device accessing said service registered on said resource discovery device, and at least one commissioning device configured to verify said constrained device providing said service is disclosed.

At block 1002, a domain lookup is performed on the resource discovery device by provisioning server or the apparatus.

At block 1004, the provisioning server or the apparatus obtains at least one service information including at least one pre-registered service along with associated device identification (ID) is obtained from said commissioning device.

At block 1006, a specific domain and a specific group of services to which said service is categorized is obtained.

At block 1008, at least one service pre-registered with said resource discovery device to obtain (1008) at least one service information including at least one pre-registered service along with associated device identification (ID) is verified.

At block 1010, service information from said commissioning device is received.

At block 1012, at least one service identification (ID) against said service information received is created.

At block 1014, said admission control policy and/or said resource control policy for said service ID are created.

At block 1016, at least one request to access said service is received from said client device.

At block 1018, a lookup for service ID associated with said service in said provisioning device is performed.

At block 1020, access for said service to said client device based on said admission control policy and/or said resource control policy is granted/denied.

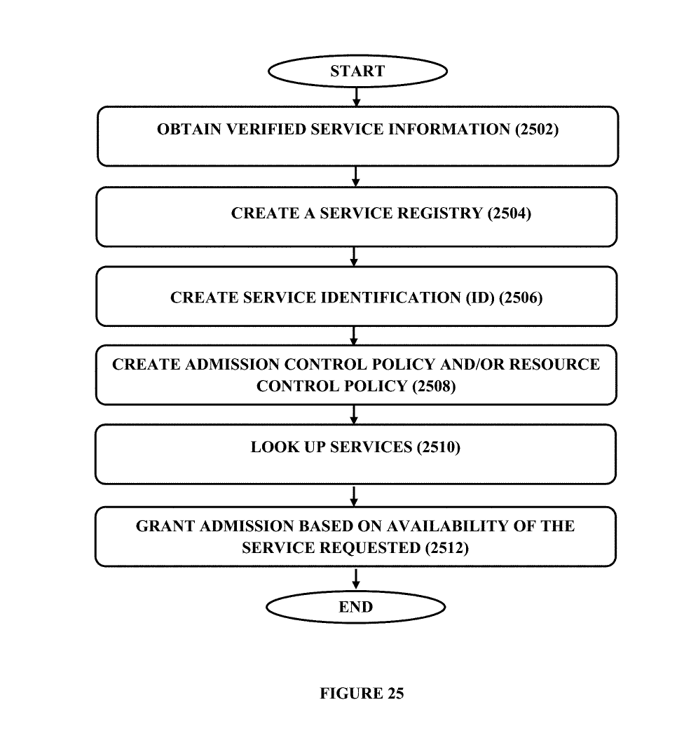

FIG. 25 illustrates a method for authorizing at least one client device to access at least one service provided by at least one resource, and managing access of the resource by providing conditional admission and/or resource control on the service provided by the resource based on service level agreement, in accordance with an aspect of the present disclosure.

At step 2502, at least one verified service information associated with at least pre-registered service provided by at least one resource is obtained.

At step 2504, at least one service registry holding the verified service information obtained is created.

At step 2506, at least one service identification (ID) against said service registry is created.

At step 2508, at least an admission control policy and/or at least a resource control policy for the service ID is created.

At step 2510, on receipt of at least one request from at least one client device to access the services, the services provided by the resources is looked up.

At step 2512, based on availability of the service requested by the client device, to access the service provided by the resource, the admission is granted to access the services based on the admission control policy and/or the resource control policy.

In one implementation, the method may receive the service information associated with the pre-registered service provided by the resource against the details of all the services provided by all the resources in a network stored in at least one database, from at least one device, the verified service information after verifying, by the device, and thereby obtain a domain information and at least one group information in which the resource is categorized from the database.

In one implementation, the method may store the verified service information in at least one database in the form of a web service.

In one implementation, the verified service information in at least one database may be stored in a web services description language (WSDL) format.

In one implementation, on receipt of the request to access the services, the method may look up all the service registry stored in the apparatus, each resource in the network comprises a service registry holding verified service information, and search, based on domain of the service or the service registry, or path associated with the service, or any combination thereof, to availability of the service requested by the client device.

In one implementation, as the present disclosure may be implemented in a wireless sensor network, the present disclosure may also be used for providing services such as:

1. Home Automation

2. Building Automation

3. Industrial Automation

4. Defense applications

5. Mining applications

6. Process Control Systems

In one implementation, the present disclosure may be implemented as a software product that implements service provisioning method of configuring policies for conditional access and resource control, which can be deployed either as a special server known as provisioning server or it can be integrated with any other centralized server such as resource directory.

In one implementation, the present disclosure may be implemented as a complete software solution for service provisioning along with commissioning procedure for constrained devices.

In one implementation, the present disclosure may be implemented as method and system for providing service provisioning in constrained environment.

In one implementation, the present disclosure may be implemented as a method to provide dynamic configuring policies for admission and resource control of constrained devices along with the commissioning procedure.

In one implementation, the present disclosure may be implemented as a method to enable dynamic resource control for service level agreements/negotiations.

In one implementation, the present disclosure may be implemented as a method to support conditional access for resources based on client's requests.

In one implementation, the present disclosure may be implemented as method to combine service commissioning with service provisioning to provide complete end-to-end authorization.

Apart from what is explained above, the present disclosure also include the below mentioned advantages:
More Secure and Safer: Unintended users may access service and cause damage to sensor device. An authentication of client devices based on secure keys alone is not sufficient to grant access for resources in critical sensor network applications. The proposed solution provides conditional access of services of resource for different clients based on service level agreements/negotiations provides better resource usage from hazards conditions. Moreover, seamlessly integrating service commissioning with service provisioning provides more security.
QoS Improvement: Sensor network applications have a variety of quality of service requirements depending on the nature of the application itself. For ex: Some of the sensor applications have data that urgently need to be delivered such as hospital wireless sensor networks (HWSN), there needs to be a method to trade of between network usage and QoS. The solution provided here allows dynamic resource control mechanism based on the service level agreements between clients and resources which improve the QoS of sensor network applications.
Maximize Device Lifetime: As the sensor devices are constrained in terms of processing power, memory, it is necessary to provision these devices (to be accessed by clients) based on its thresholds and limited access capabilities. So the solution provided here allows the sensor devices to be controlled based on their threshold limits, and limited access capabilities. This ultimately increases the sensor devices lifetime.
Improve Network Throughput: In case of congested network, controlling the admission of resource access, improves the network bandwidth usage. The dynamic admission, and resource control policies improves the network bandwidth usage based on network conditions.
Easy Maintenance: Dynamic admission and resource control makes the user more comfortable to access the service in largely deployed sensor devices (which eliminates the unnecessary overhead in maintenance of resource changes). It is easy to monitor and observe connectivity statistics of services.

A person of ordinary skill in the art may be aware that in combination with the examples described in the embodiments disclosed in this specification, units and algorithm steps may be implemented by electronic hardware, or a combination of computer software and electronic hardware. Whether the functions are performed by hardware or software depends on the particular applications and design constraint conditions of the technical solution. A person skilled in the art may use different methods to implement the described functions for each particular application, but it should not be considered that the implementation goes beyond the scope of the present disclosure.

It may be clearly understood by a person skilled in the art that for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

When the functions are implemented in a form of a software functional unit and sold or used as an independent product, the functions may be stored in a computer-readable storage medium. Based on such an understanding, the technical solutions of the present disclosure essentially, or the part contributing to the prior art, or a part of the technical solutions may be implemented in a form of a software product. The computer software product is stored in a storage medium, and includes several instructions for instructing a computer device (which may be a personal computer, a server, or a network device) to perform all or a part of the steps of the methods described in the aspect of the present disclosure. The foregoing storage medium includes: any medium that can store program code, such as a USB flash drive, a removable hard disk, a read-only memory (Read-Only Memory, ROM), a random access memory (Random Access Memory, RAM), a magnetic disk, or an optical disc.

Although implementations for methods, systems, and apparatuses of service provisioning for resource management in a constrained environment have been described in language specific to structural features and/or methods, it is to be understood that the appended claims are not necessarily limited to the specific features or methods described. Rather, the specific features and methods are disclosed as examples of implementations of methods, systems, and apparatuses of service provisioning for resource management in a constrained environment.

We claim:

1. An apparatus, comprising:
a memory; and
a processor coupled to the memory, the processor configured to perform acts comprising:
obtaining at least one verified service information associated with at least pre-registered service provided by at least one resource;
creating at least one service registry holding the verified service information obtained;
creating at least one service identification (ID) against the service registry created;
creating at least one of an admission control policy and a resource control policy for the service ID created;
when receiving at least one request from at least one client device to access the services, looking up services provided by the at least one resource; and
based on availability of the service requested by the client device, granting admission to access the service provided by the resource, based on at least one of the admission control policy and the resource control policy.

2. The apparatus as claimed in claim 1, wherein the acts further comprise:
authorizing at least one client device to access at least one service provided by at least one resource, and
authorizing access management of the resource by providing at least one conditional admission and resource control on the service provided by the resource based on service level agreement dynamically.

3. The apparatus as claimed in claim 1, wherein the verified service information is received from at least one device configured to verify service information associated with the pre-registered service provided by the resource against the details of all the services provided by all the resources in a network stored in at least one database, and thereby obtaining, from the database, a domain information and at least one group information in which the resource is categorized.

4. The apparatus as claimed in claim 1, wherein the verified service information is stored in at least one database in the form of a web service.

5. The apparatus as claimed in claim 1, wherein the verified service information is stored in at least one database in the form a web service in a web services description language (WSDL) format.

6. The apparatus as claimed in claim 1, wherein the admission control policy is at least one of read (R), write (W), read/write (R/W), delete (D), number of simultaneous connection on a resource, or any combination thereof.

7. The apparatus as claimed in claim 1, wherein the resource control policy comprises at least one of:
a conditional access of a service;
quality of service agreements; and
parameters based on priority levels set for the client device, wherein the resource control policy depends on at least one application used by the client device.

8. The apparatus as claimed in claim 1, wherein the service registry comprises at least one of resource identification, a group in which the resource is categorized, a domain detail, a type of resource, a resource IP, or any combination thereof.

9. The apparatus as claimed in claim 1, wherein on receipt of the request to access the services, the processor is further configured to execute acts comprising:
looking up all the service registry stored in the apparatus, each resource in the network comprises a service registry holding verified service information; and
searching based on domain of the service or the service registry, or path associated with the service, or any combination thereof, to availability of the service requested by the client device.

10. A method, comprising:
obtaining at least one verified service information associated with at least pre-registered service provided by at least one resource;
creating:
at least one service registry holding the verified service information obtained;
at least one service identification (ID) against the service registry;
at least an admission control policy and a resource control policy for the service ID;
looking up, when receiving at least one request from at least one client device to access the services, services provided by the at least one resource;
granting admission, based on availability of the service requested by the client device, to access the service provided by the resource, based on at least one of the admission control policy and the resource control policy; and
authorizing at least one client device to access at least one service provided by the at least one resource, and managing access of the resource by providing at least one conditional admission and resource control on the service provided by the resource based on service level agreement.

11. The method as claimed in claim 10, comprises:
receiving, from at least one device, the verified service information after verifying, by the device, the service information associated with the pre-registered service provided by the resource against the details of all the services provided by all the resources in a network stored in at least one database, and thereby
obtaining, from the database, a domain information and at least one group information in which the resource is categorized.

12. The method as claimed in claim 10, comprises storing the verified service information in at least one database in the form of a web service.

13. The method as claimed in claim 10, comprises storing the verified service information in at least one database in a web services description language (WSDL) format.

14. The method as claimed in claim 10, wherein the admission control policy is at least one of read (R), write (W), read/write (R/W), delete (D), number of simultaneous connection on a resource, or any combination thereof.

15. The method as claimed in claim 10, wherein the resource control policy is a conditional access of a service, and/or quality of service agreements/parameters based on priority levels set for the client device and depending on at least one application used by the client device.

16. The method as claimed in claim 15, wherein the quality of service agreements/parameters is at least one of availability, reliability, serviceability, data accuracy, aggregation delay, coverage, fault tolerance, network lifetime or any combination thereof, associated with the network.

17. The method as claimed in claim 15, wherein the quality of service (QoS) agreements/parameters are categorized in at least one group, at least one priority, at least one class, and at least one permission.

18. The method as claimed in claim 10, wherein the service registry comprises at least one of resource identification, a group in which the resource is categorized, a domain detail, a type of resource, a resource IP, or any combination thereof.

19. The method as claimed in claim 10, wherein on receipt of the request to access the services, the method comprises:
looking up all the service registry stored in the apparatus, each resource in the network comprises a service registry holding verified service information; and
searching, based on domain of the service or the service registry, or path associated with the service, or any combination thereof, to availability of the service requested by the client device.

20. A method for provisioning at least one admission control policy and/or at least one resource control policy to at least one service in a network, said network having at least one constrained device providing said service registered with at least one resource discovery device, at least one client device accessing said service registered on said resource discovery device, and at least one commissioning device configured to verify said constrained device providing said service, said method comprising:
obtaining, by a provisioning device in said network, at least one service information including at least one pre-registered service along with associated device identification (ID) from said commissioning device;
creating, by said provisioning device, at least one service identification (ID) against said service information received;
creating, by said provisioning device, said admission control policy and/or said resource control policy for said service ID; and
on receipt of at least one request, from said client device, to access said service, looking up, by said provisioning device, service ID associated with said service in said provisioning device; and thereby granting or denying, by said provisioning device, access for said service, based on said admission control policy and/or said resource control policy, to said client device.

21. The method as claimed in claim 20, further comprises: transmitting, by said provisioning device, said service identification (ID) to said commissioning device, to perform at least one operation, preferably delete operation, on said service registered against said service ID.

22. The method as claimed in claim 20, wherein said admission control policy is at least one of read (R), write (W), read/write (R/W), delete (D), number of simultaneous connection on a resource, or any combination thereof.

23. The method as claimed in claim 20, wherein said resource control policy comprises at least one of:
a conditional access of a service;
quality of service agreements; and
parameters based on priority levels set for said client device, wherein the resource control policy depends on at least one application used by said client device.

24. The method as claimed in claim 22, wherein said quality of service agreements/parameters is at least one of availability, reliability, serviceability, data accuracy, aggregation delay, coverage, fault tolerance, network lifetime or any combination thereof, associated with said network.

25. The method as claimed in claim 24, wherein said quality of service (QoS) agreements/parameters are categorized in at least one group, at least one priority, at least one class, and at least one permission.

26. The method as claimed in claim 20, wherein said service information comprises at least one of device identification, a group in which said device categorized, a domain detail, a type of device, a device IP, or any combination thereof.
